(19) United States
(12) Patent Application Publication
(10) Pub. No.: US 2020/0276744 A1
(43) Pub. Date: Sep. 3, 2020

(54) DEVICE FOR CONTINUOUSLY DOSING PLASTIC MATERIAL, ESPECIALLY FOR A UNIT FOR PRODUCING COMPONENTS MADE OF PLASTIC MATERIAL OR THE LIKE

(71) Applicants: Jean-Pierre Voigtmann, Muraz (CH); Daniel Kohlenbrenner, Miex (CH)

(72) Inventors: Jean-Pierre Voigtmann, Muraz (CH); Daniel Kohlenbrenner, Miex (CH)

(73) Assignee: INOVIA TECHNOLOGIES SA, Bex (CH)

(21) Appl. No.: 16/076,147

(22) PCT Filed: Feb. 10, 2017
(86) PCT No.: PCT/EP2017/053088

§ 371 Date: Aug. 7, 2018

(30) Foreign Application Priority Data
Feb. 10, 2016 (EP) PCT/EP2016/052861

(51) Int. Cl. B29C 48/00; B29C 48/09

(52) U.S. Cl. CPC B29C 48/0022; B29C 2793/009; B29C 48/09

(57) ABSTRACT

A dosing device for dosing plastic material, comprising an extrusion head that has a dispensing opening commonly called a die and a punch extending into the dispensing opening, coaxially thereto, for continuously extruding a plastic material in the form of a tubular or annular body, and a cutter for separating a dose of said plastic material in the form of a tubular or annular section. The cutter includes at least two elements having at least one cutting edge extending on either side of the dispensing opening and secured to a driver for symmetrically moving the at least two elements in relation to a longitudinal axis of the extruded tubular body until the tubular body is severed by said at least two elements in order to form a dose.

### TECHNICAL FIELD

The present invention relates to the field of devices for dosing plastic material or the like, for dosing any type of pasty material cold or hot, such as a thermoplastic (PE, PP, PA, etc.) or an elastomer (natural or synthetic rubber), for example. It more particularly relates to a dosing device suitable for a unit for producing components made from plastics such as flexible tubes made from plastic comprising a skirt and a shoulder, obtained from prefabricated tubular bodies.

### BACKGROUND OF THE INVENTION

It is well known that in general, a flexible tube is made by assembling two parts manufactured separately, namely a cylindrical flexible skirt with a predetermined length and a head comprising a neck with a dispensing orifice and a shoulder connecting said neck to said cylindrical skirt.

Said head, which is generally made from plastic, can either be molded separately, then welded on one end of the cylindrical skirt, or molded and welded autogenously to the cylindrical skirt by any method known by those skilled in the art, for example an injection molding method or a compression molding method for an extruded blank, for example.

To that end, it is known to use a so-called dosing device integrated onto a tube production machine. Said dosing device deposits, on a mandrel or in a mold, the quantity necessary for molding of the head comprising a neck with a dispensing orifice, according to a method commonly called compression-molding.

However, the dosing devices of the prior art have many drawbacks. A first drawback lies in the fact that these devices most often work in a discontinuous mode, which does not make it possible to achieve a high production rhythm.

This is in particular the case for document WO2005/072051, which describes a device for dosing plastic discontinuously in which, in a first phase, a cavity is filled via a filling conduit, then, in a second phase, the cavity is isolated by closing the filling conduit before a third and final phase, in which the material is expelled from the cavity using a piston during the opening of a valve. The material is sectioned when the valve is closed to form the dose.

During the closing of the filling conduit, the material coming from the extruder must be stored in an accumulator, which is filled and emptied upon each cycle, since the extruder cannot be stopped and restarted so quickly.

Furthermore, these various channels filled with material and these multitudes of moving parts, also in contact with the material, make a change of color more difficult and time-consuming.

Devices for dosing plastic material are described in documents WO 2007/028723, WO 03/047823, WO 2015/181668 and WO 97/18073.

Document WO 2007/028723, which describes a device that comprises an extrusion channel provided with a dispensing opening serving to extrude a fluidifiable material in an exit direction through the dispensing opening and a cutting means serving to separate a dose of said fluidifiable material, this cutting means being removable with a movement component parallel to the exit direction. More specifically, the cutting means are made up of a blade secured to a support means rotated by an electric motor, said blade extending in an oblique plane relative to the longitudinal axis of the drive shaft of said electric motor.

This type of device does not allow the formation of a dose having a tubular or annular shape.

Document WO 03/047823 describes a device for forming annular blanks, intended to cut rings with a predetermined thickness of an extruded tube made from a synthetic material comprising, above the outlet mouth of the extruder, a removable body bearing at least one stationary rear blade and at least one removable blade between a working position in which it interacts with the inner edge of part of said tube and an idle position in which it is separated from said edge.

This type of device has the drawback of transferring the annular dose transversely relative to the extrusion direction, which risks deforming the dose during the transfer, in particular for low-viscosity plastic materials at the outlet of the extrusion channel. Furthermore, it is not suitable for forming tubular doses or annular doses having a very small section.

Document WO 2015/181668 describes a method and a device that make it possible to form annular doses, a flow of plasticized material, supplied by an extruder, passing in a channel that is first cylindrical, then annular, and exiting through an annular outlet across from which a cutting element passes that separates an annular dose of material, the latter being deposited on a surface of a capsule, the ability of which to stick to the dose is greater than that of the cutting element; the surface and the cutting element being placed at a certain distance from one another such that the annular dose, remaining adhered to the capsule, is detached from the element; the detachment being able to be encouraged by a flow of air.

This type of device has the drawback of operating discontinuously, i.e., the flow of plastic material at the outlet of the extrusion channel is interrupted during each cut to form an annular dose, such that it allows a slower manufacturing rhythm than the manufacturing rhythm of a device that operates continuously. Furthermore, extruded plastic becomes housed between the cylindrical cutting element, which assumes the form of a ring moving via a vertical to-and-fro movement, and the outer wall of the extrusion head such that the movements of the ring heat, then carbonize said plastic, procuring fine black particles that tend to pollute the produced doses.

Document WO 97/18073 describes a dosing device comprising a mandrel oriented upward, the upper end of which is made in the form of an inner compression die for the head and the shoulder of the tube, as well as a dosing device for extruding the provided quantity of plastic material used to subsequently make the head and shoulder. The dosing device has a polystructured hollow body, in which a discharge member is movable longitudinally via a push rod. The structure of a hollow body is made up of a supply chamber, a discharge chamber, a first intermediate chamber and a second intermediate chamber. Connected to the second intermediate chamber is the extrusion nozzle, which may have, depending on the desired form of a plastic blank to be produced, an annular space or a circular opening. The first intermediate chamber is connected to the second by openings. The discharge member bears the push rod, a discharge piston and, on the side opposite the push rod, a rod that ends in a valve piston. By movement of the push rod, the discharge piston causes the desired quantity of plastic material forming the annular blank to leave the discharge chamber by compression, said plastic material being expelled into the annular space, cut by an annular blade moved vertically and brought into the inner compression die. During the following operating cycle, the blank (5) is configured so as to assume the form of the head and the shoulder of the tube and is compressed jointly with the body of the tube fastened on the mandrel.

In the same way as before, this type of device has the drawback of operating discontinuously, such that it allows a slower manufacturing rhythm than the manufacturing rhythm of a device that operates continuously.

### BRIEF DESCRIPTION OF THE INVENTION

One aim of the invention is to resolve at least one of these drawbacks by proposing a dosing device with a simple and inexpensive design making it possible to form doses from a plastic or similar material extruded continuously.

To that end, and according to the invention, proposed is a device for continuous dosing of plastic or the like comprising an extrusion head having a dispensing orifice, commonly called channel, and a punch extending in the dispensing orifice coaxially thereto in order to continuously extrude a plastic in the form of a tubular or annular body and cutting means for separating a dose of said plastic in the form of a tubular or annular section; said device is remarkable in that said cutting means are made up of at least two elements having at least one cutting or sharp edge, extending on either side of the dispensing orifice, and secured to driving means procuring a symmetrical movement of said elements relative to the longitudinal axis of the extruded tubular body until the tubular body is sectioned by said elements to form a dose.

Advantageously, the trajectory followed by the cutting or sharp edge of each element is a closed trajectory.

Furthermore, the cutting or sharp edge of each element includes, over at least part of the trajectory, a movement speed component in a direction perpendicular to the extrusion direction and a movement speed component in the same direction as the extrusion direction.

Preferably, the movement speed component in the same direction as the extrusion direction is substantially identical to the movement speed of the continuously extruded tubular body.

Preferably, after the sectioning of the tubular body, the trajectory of the cutting or sharp edge of each element includes a movement speed component in the extrusion direction greater than the movement speed of the tubular body in order to propel the dose in the extrusion direction.

Said punch comprises at least a first cylindrical so-called inner part with a diameter slightly smaller than the inner diameter of the dispensing orifice and a so-called transition part protruding from the dispensing orifice and which is frustoconical.

According to one alternative embodiment of the dosing device according to the invention, said punch comprises a first cylindrical so-called inner part with a diameter slightly smaller than the inner diameter of the dispensing orifice and a second so-called outer part, also cylindrical, with a diameter larger than the diameter of the inner part, the transition between the inner part and the outer part of the punch having a frustoconical shape.

Preferably, each element has a cutout positioned at the cutting or sharp edge of said element.

Said cutout has an arc of circle shape with a curve radius substantially equal to the curve radius of the outer part of the punch.

Preferably, said cutout has dimensions slightly larger than the dimensions of the outer part of the punch so as to procure clearance between said elements and said punch.

Moreover, the trajectory followed by the cutting or sharp edge of each element is a closed trajectory comprising at least three separate parts, a first part called cutting part in which the cutting or sharp edge of each element has a movement speed component essentially in a direction perpendicular to the extrusion direction until the cutting or sharp edge is aligned with the extrusion head, a second part called evacuation part in which the cutting or sharp edge of each element has a movement speed component essentially in a direction parallel to the extrusion direction, the cutting or sharp edge of each element procuring the sectioning of the tubular body to form the dose when said elements reach the distal end of the transition part of the punch, and a part called return part in which the cutting or sharp edge of each element has a movement speed component in a direction parallel to the extrusion direction and a movement speed component in a direction perpendicular to the extrusion direction.

According to one alternative embodiment, the trajectory followed by the cutting or sharp edge of each element is a closed trajectory comprising at least three separate parts, a first part called cutting part in which the cutting or sharp edge of each element has a movement speed component in a direction perpendicular to the extrusion direction and a movement speed component in a direction parallel to the extrusion direction until the cutting or sharp edge passes through the wall of the extruded tubular body at the transition part of the punch protruding from the dispensing orifice, the cutting or sharp edge of each element then procuring the sectioning of the tubular body to form the dose, a second part called evacuation part in which the cutting or sharp edge of each element has a movement speed component essentially in a direction parallel to the extrusion direction, and a part called return part in which the cutting or sharp edge of each element has a movement speed component in a direction parallel to the extrusion direction and a movement speed component in a direction perpendicular to the extrusion direction.

According to another alternative embodiment, the trajectory followed by the cutting or sharp edge of each element is a closed trajectory comprising at least three separate parts, a first part called cutting part in which the cutting or sharp edge of each element has a movement speed component in a direction perpendicular to the extrusion direction and a movement speed component in a direction parallel to the extrusion direction until the cutting or sharp edge passes through the wall of the extruded tubular body at the outer part of the punch protruding from the dispensing orifice, the cutting or sharp edge of each element then procuring the sectioning of the tubular body to form the dose, a second part called evacuation part in which the cutting or sharp edge of each element has a movement speed component essentially in a direction parallel to the extrusion direction, and a part called return part in which the cutting or sharp edge of each element has a movement speed component in a direction parallel to the extrusion direction and a movement speed component in a direction perpendicular to the extrusion direction.

Preferably, the cutting or sharp edge passes through the wall of the extruded tubular body at the free end of the outer part of the punch protruding from the dispensing orifice.

Alternatively, the cutting or sharp edge passes through the wall of the extruded tubular body at the outer part of the punch protruding from the dispensing orifice, in the central part of said outer part.

According to another alternative, the cutting or sharp edge passes through the wall of the extruded tubular body at the outer part of the punch protruding from the dispensing orifice, in the proximal part of said outer part, i.e., near the transition part of said punch.

### BRIEF DESCRIPTION OF THE DRAWINGS

Other details of the invention will appear more clearly upon reading the following description, done in reference to the appended drawing, in which:

FIG. 1 is a perspective view of the tower, the tool station and means for transferring a flexible tube assembly device comprising a so-called dosing device made up of an extruding device and cutting means for separating a dose according to the invention,

FIG. 2 is a perspective view of the dosing device according to the invention,

FIG. 3 is a schematic elevation view of the dosing device according to the invention,

FIGS. 4 to 7 are perspective views of the dosing device according to the invention, during different cutting steps of the tubular body extruded to form the dose,

FIG. 8 is an elevation view of the dosing device according to the invention showing the trajectory of the cutting blades,

FIG. 9 is a schematic elevation view of a first alternative embodiment of the dosing device according to the invention,

FIGS. 10 to 13 are perspective views of the first alternative embodiment of the dosing device according to the invention, during different cutting steps of the tubular body extruded to form the dose,

FIG. 14 is a schematic elevation view of the first alternative embodiment of the dosing device according to the invention, showing the trajectory of the cutting blades,

FIG. 15 is a schematic elevation view of a second alternative embodiment of the dosing device according to the invention, showing the trajectory of the cutting blades,

FIGS. 16 to 18 are perspective views of a third alternative embodiment of the dosing device according to the invention, during different cutting steps of the tubular body extruded to form the dose.

### DETAILED DESCRIPTION OF THE INVENTION

Below, we describe an installation for manufacturing and filling flexible tubes, and more particularly a device for assembling flexible tubes comprising a dosing device according to the invention; however, it is clear that the dosing device according to the invention may be suitable for dosing any type of cold or hot pasty material, such as a thermoplastic (PE, PP, PA, etc.) or an elastomer (natural or synthetic rubber), for example, without going beyond the scope of the invention.

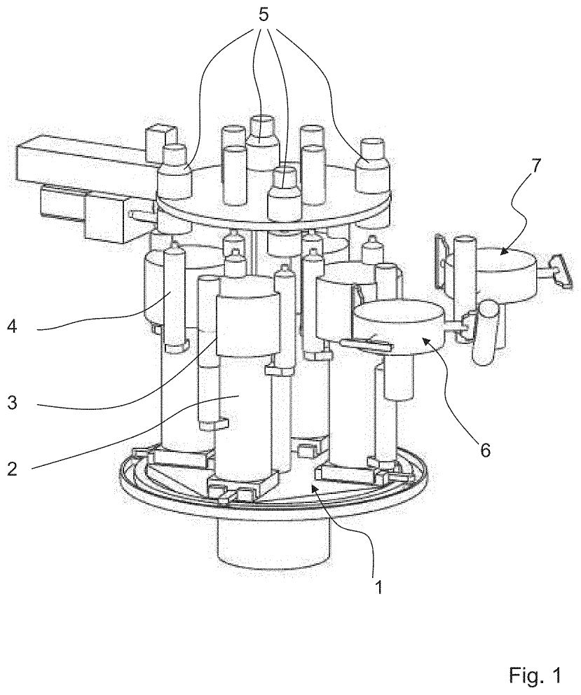

In reference to FIG. 1, said assembly device, which is described in more detail in international patent application PCT/EP2016/052861 by the applicant, is made up of transport means 1 along a so-called main closed trajectory and a plurality of so-called satellite towers 2 mounted rotating on said transport means 1, said satellite towers 2 including means for retaining a plurality of skirts and each satellite tower 2 being rotated by a predetermined angle around its rotation axis when said satellite tower 2 reaches at least one predetermined point of the main trajectory. Said transport means 1 consist of a so-called main tower 1 rotated around its vertical axis of symmetry and the retaining means of the satellite towers 2 consist of semi-cylindrical cavities 3, the axes of which extend parallel to the rotation axis of each satellite tower 2, each cavity 3 including suction means for keeping the prefabricated tubular bodies, i.e., the skirts, in place in said cavities 3.

Furthermore, the device includes a plurality of mandrels 4 extending in line with said retaining means 3 and able to move from a retracted position toward a so-called treatment position in which said mandrels 4 extend inside the prefabricated tubular bodies, i.e., the skirts. Said device also includes means for actuating the mandrels 4 from their retracted position toward their treatment position, said actuating means not being shown in FIG. 1. These actuating means of the mandrels 4 preferably consist of mechanical actuating means made up of stationary mechanical cams extending around the main tower. However, said actuating means of the mandrels 4 may consist of electric and/or pneumatic and/or hydraulic actuating means without going beyond the scope of the invention.

Said assembly device comprises work stations 5 extending above the main tower 1 and satellite towers 2, as well as a loading tower 6 and an unloading tower 7 positioned at the periphery of the main tower 1. Said main 1, loading 6 and unloading 7 towers all rotate continuously. Preferably, the tangential speed of the skirts in the cavities of the loading 6 and unloading 7 towers is substantially identical to the tangential speed of the skirts in the outer cavities 3 of the satellite towers 2, which allows an easy transfer of the skirts.

The cavities of the loading 6 and unloading 7 towers are provided with gripping members including a slit, not shown in the figures, through which a vacuum is exerted making it possible to produce suction and optionally blowing, in order to provide effective fixing (suction) or removal (blowing) of the skirts.

Each satellite tower 2 has a same lot of work stations 5. Each lot of work stations 5 comprises one or several work stations that will successively carry out the various steps to assemble the tube components. The work stations 5 are mounted movable along a vertical movement axis so as to be able to come into contact with the two components once the satellite tower 2 is no longer rotating or moving radially, and to release the satellite tower 2 just before the beginning of the rotation of the latter.

Of course, the transport means 1 may be replaced by any other transport means well known by those skilled in the art without going beyond the scope of the invention.

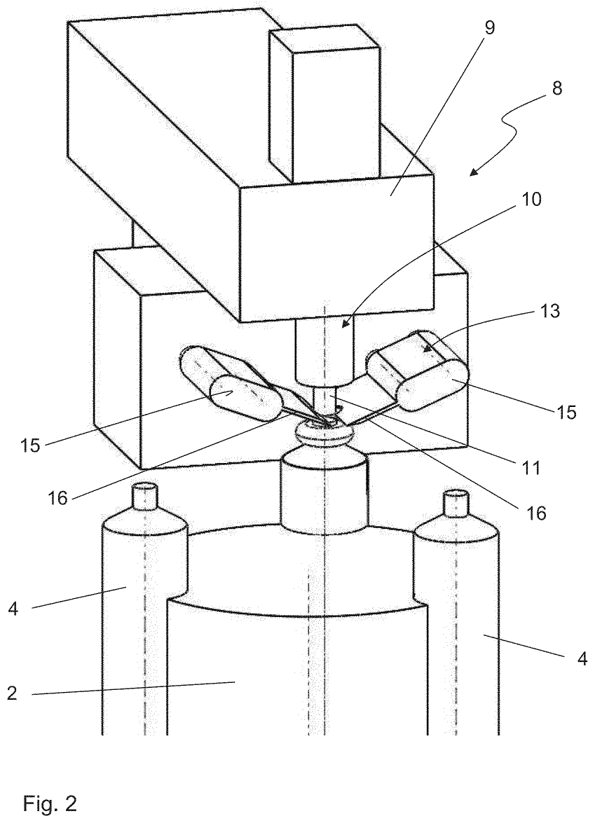

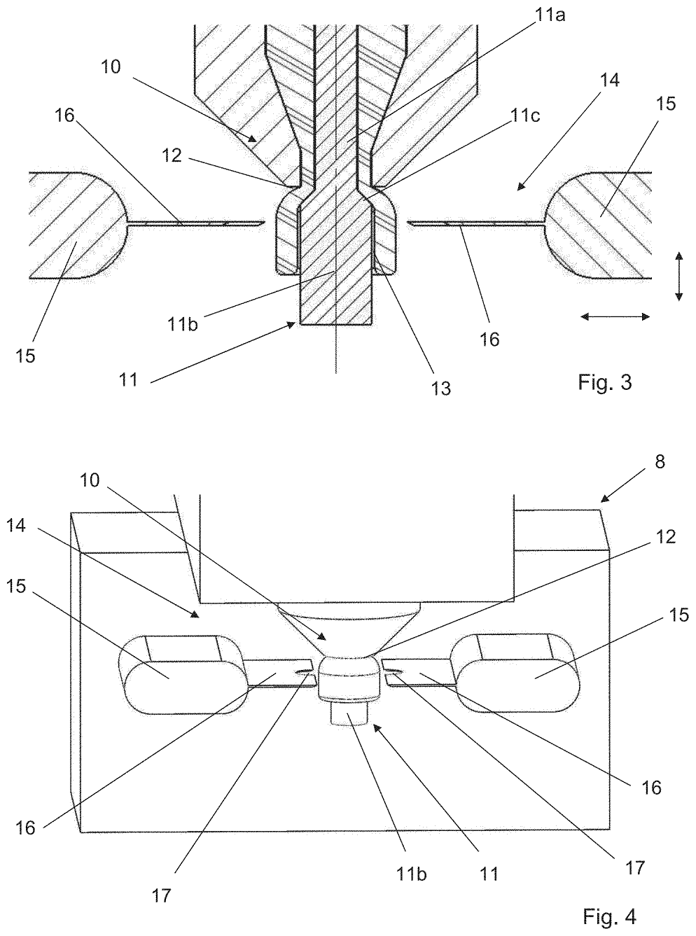

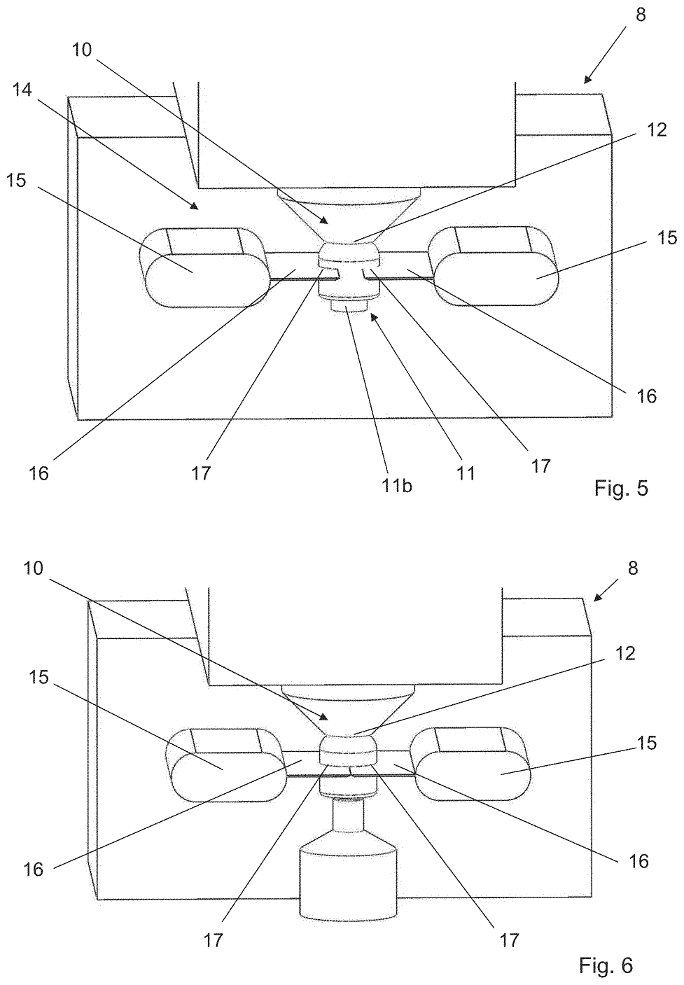

Furthermore, in reference to FIGS. 2 to 7, one of the tools of the work stations 5 of the assembly device consists of a so-called dosing unit 8 that is positioned above the stopping point of the satellite towers 2. This dosing unit 8 makes toroidal doses of plastic, i.e., tubular or annular, with a central hole, more commonly called “donut” or “rolling”. The dosing unit 8 is made up of an extruder 9 making it possible to melt the plastic particles and to transfer this viscous material continuously under high pressure into a dosing head 10 also called extrusion channel. Said dosing head 10 will extrude a tubular or annular plastic body vertically against the bottom around a punch 11 extending from the dispensing orifice 12, coaxially to said extrusion orifice 12, while protruding from the latter. This punch 11 therefore extends inside the dispensing orifice 12 and has a first cylindrical so-called inner part 11a with a diameter slightly smaller than the inner diameter of the dispensing orifice 12 and a second so-called outer part 11b, also cylindrical, with a diameter larger than the inner diameter of said dispensing orifice 12, the transition between the inner part 11a and the outer part 11b of the punch 11 having a frustoconical shape 11c.

Advantageously, and based on the behavior of the extruded material, for example based on its viscosity, an air knife 13 is created around the punch 11 facilitating the advance of the material of the extruded tubular body against the bottom without having a sticking effect on said punch 11. This air knife 13 is created under the effect of the rapid exit of the material toward the dispensing orifice 12 based on the space and the geometry between the punch 11 and the extrusion channel.

The dosing unit 8 also includes a cutting device 14 that sections the tubular body into equal lengths so as to create annular or tubular doses, which are next directly deposited successively on the mandrel heads 4. Said cutting device 14 placed below the dosing head 10 comprises a transmission box for example actuated with a servomotor that drives two axes emerging from the gearbox. On each axis is a blade holder 15 respectively holding a blade 16 such that said blades 16 are located on either side of the punch 11. These blades 16 perform a movement along a closed trajectory with a speed component perpendicular to the extrusion direction and a speed component parallel to the extrusion direction, the extrusion direction being parallel to the axis of the extrusion head, and oriented downward in this example embodiment, relative to the tubular body extruded continuously around the punch 11, come closer to one another until touching, thus sectioning the extruded tubular body around the outer part 11b of the punch 11, just below the transition part 11c of said punch 11.

It will be noted that the blades 16 may not touch one another, but overlap slightly, over several hundredths of millimeters, without going beyond the scope of the invention.

Thus, first, when the blades 16 come closer to the punch 11, at the outer part 11b of the punch 11, just below the transition part 11c of said punch 11, the trajectory done by the sharp edge of each blade 16 is done substantially horizontally with a movement speed component perpendicular to the extrusion direction and a movement speed in the extrusion direction, i.e., downward, substantially identical to the movement speed of the tubular body extruded continuously until the extruded tubular body is sectioned to form a dose. The cutting thus obtained is clean without stretching of the extruded tubular body. Indeed, during the sectioning movement, the relative speed between the sharp edge of each blade 16 and the extruded tubular body is nil.

Secondly, when the blades 16 move away from the punch 11, the trajectory followed by the sharp edge of each blade is also done horizontally, but with a movement speed component against the bottom much greater than the movement speed of the tubular body with a great acceleration at the beginning of the movement, subsequently lessening quickly, thereby creating a propulsion of the dose against the bottom and a fast and safe deposition, on the heads of the mandrel, owing to the accompanying of the blades.

This movement may be obtained using a connecting rod assembly placed appropriately and driven by an axis rotating continuously able to move perpendicular and parallel to the extrusion direction, for example, and by any other equivalent means.

Preferably, the blades 16 are open-worked toward the center of the sharp edge of the blade 16 with a half-moon shape with a size slightly larger than the diameter of the outer part 11b of the punch 11, such that when the blades 16 touch or overlap, an infinitely small clearance lies between the blades 16 and the punch 11. Thus, each blade 16 includes a semicircular cutout 17.

However, the cutout 17 may of course have any shape corresponding to the shape of the cross-section of the punch 11. Furthermore, the cross-section 17 is not necessarily in the central part of the sharp edge of the blade 16 without going beyond the scope of the invention.

Infinitely small clearance refers to a clearance of several hundreds of millimeters to several tenths of millimeters based on the outer diameter of the extruded tubular body to be cut. This cutting system thus guarantees the central hole in the dose. It will be noted that the devices of the prior art have a high likelihood of closing the central hole, since when the blades come into contact with the tubular body, they crush the walls of the tubular body and bring them closer together, thus closing the central hole. Yet the central hole is essential to guarantee correct molding of a tube shoulder with an orifice having a skirt.

It will be noted that in this particular example embodiment, the cutting device includes two blades 16 extending on either side of the punch 11, symmetrically on either side of the extrusion head axis, i.e., on either side of the flow axis of the extruded tubular body; however, it is quite clear that the cutting device may comprise more than two blades 16 without going beyond the scope of the invention.

Furthermore, the horizontal and vertical movement of the blades 16 may be sequential and not combined without going beyond the scope of the invention.

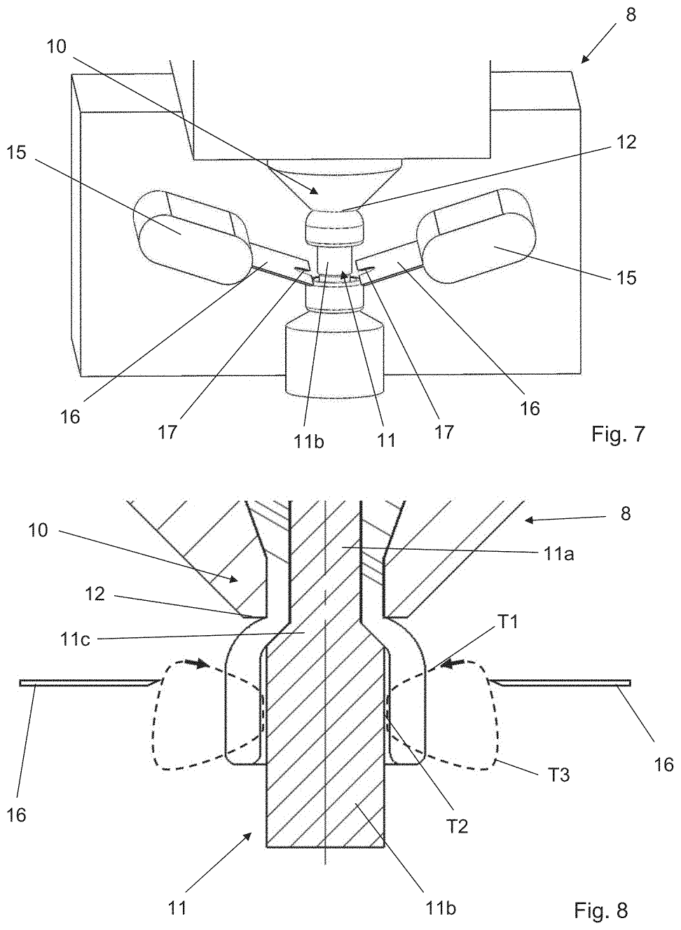

In reference to FIG. 8, the closed trajectory (T) of the sharp edge of the blades 16 comprising at least three separate parts, a first part (T1) called cutting part in which the cutting or sharp edge of each blade has a movement speed component essentially in a direction perpendicular to the extrusion direction until the cutting or sharp edge passes through the wall of the extruded tubular body at the outer part 11b of the punch 11, a second part (T2) called evacuation part in which the cutting or sharp edge of each blade 16 has a movement speed component essentially in a direction parallel to the extrusion direction, i.e., downward in this example embodiment, the cutting or sharp edge of each blade 16 then procuring the sectioning of the tubular body to form the dose when said blades reach the punch 11, and a third part (T3) called return part in which the cutting or sharp edge of each blade 16 has a movement speed component in a direction parallel to the extrusion direction and a movement speed component in a direction perpendicular to the extrusion direction moving away from the punch 11 in order to move the sharp edge of each blade 16 into its initial position for a new cycle.

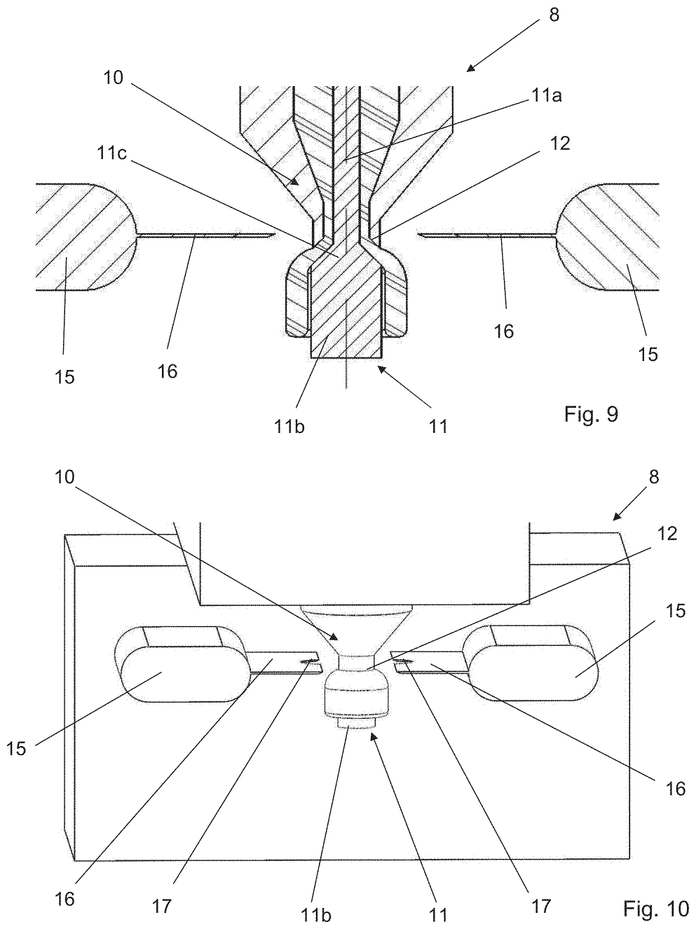

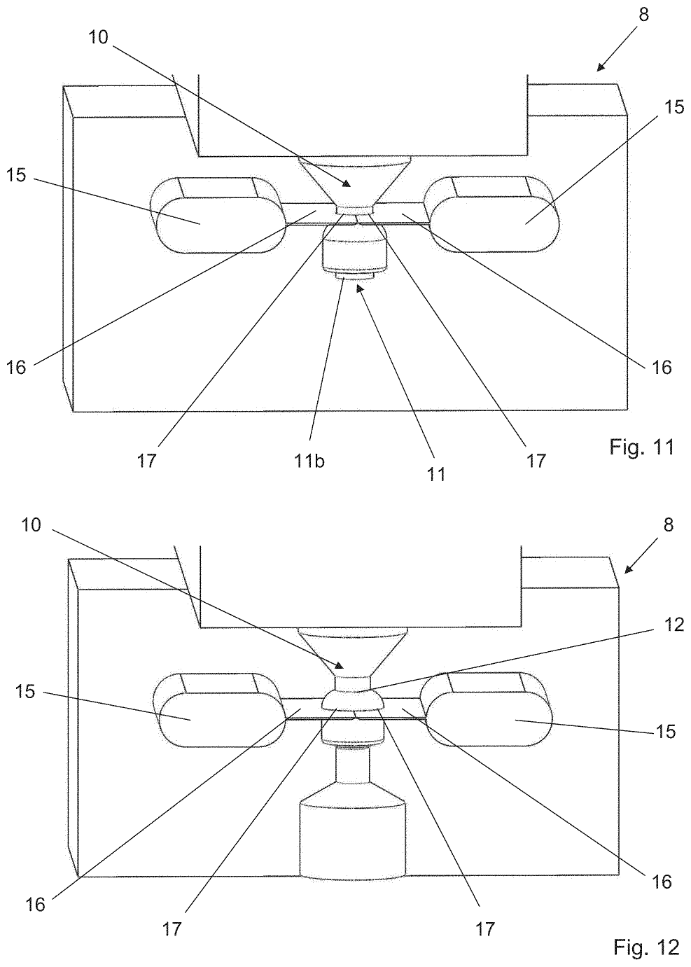

According to a first alternative embodiment of the device according to the invention, in reference to FIGS. 9 to 13, the connecting rod assembly driving the blade holders 15 is chosen such that the movements of the blades 16 are modified so as to obtain sectioning of the extruded tubular body vertically from top to bottom and not laterally as described in the previous alternative. First (FIG. 10), the blades 16 are placed in contact concentrically on the dosing head 10 just above the beginning of the formation of the extruded tubular body on the punch 11. To that end, the blades 16 are moved along a closed trajectory with a movement speed essentially perpendicular to the extrusion direction. Secondly (FIG. 11), the trajectory followed by the sharp edge of each blade 16 is done with a movement speed essentially parallel to the extrusion direction, i.e., against the bottom, with a movement speed component substantially identical to the movement speed of the extruded tubular body until the extruded tubular body is sectioned, the sectioning of the extruded tubular body being done when the sharp edge of each blade 16 is at the height of the base of the punch 1, which corresponds to the location or space between the sharp edge of each blade 16 and the punch 11 being practically nil. The cutting thus obtained is clean and without stretching of the extruded tubular body. Indeed, during the sectioning movement, the relative speed between the sharp edge of each blade 16 and the extruded tubular body is nil. Third (FIG. 11), when the blades 16 move away from the punch 11, the trajectory followed by the sharp edge of each blade 16 is done horizontally with a movement speed component against the bottom much greater than the movement speed of the extruded tubular body with a great acceleration at the beginning of the movement, subsequently lessening quickly, thereby creating a propulsion of the dose of material against the bottom and a fast and safe deposition, on the heads of the mandrel (FIG. 13) owing to the accompanying of the blades 16.

It will be noted that, like before, the horizontal and vertical movement of the blades may be sequential and not combined without going beyond the scope of the invention.

Furthermore, it will be noted that the two blades 16 can be replaced by another sharp element such as a two-part ring, each ring including a cutting or sharp edge, without going beyond the scope of the invention.

Additionally, note will be made that the cutting zone of the extruded tubular body, i.e., the position in which the blades 16 come in to contact or overlap, may be in any location on the punch 11, i.e., on the transition part 11c and the outer part 11b of the punch 11, but also just below the distal end of the outer part 11b of said punch 11 without going beyond the scope of the invention.

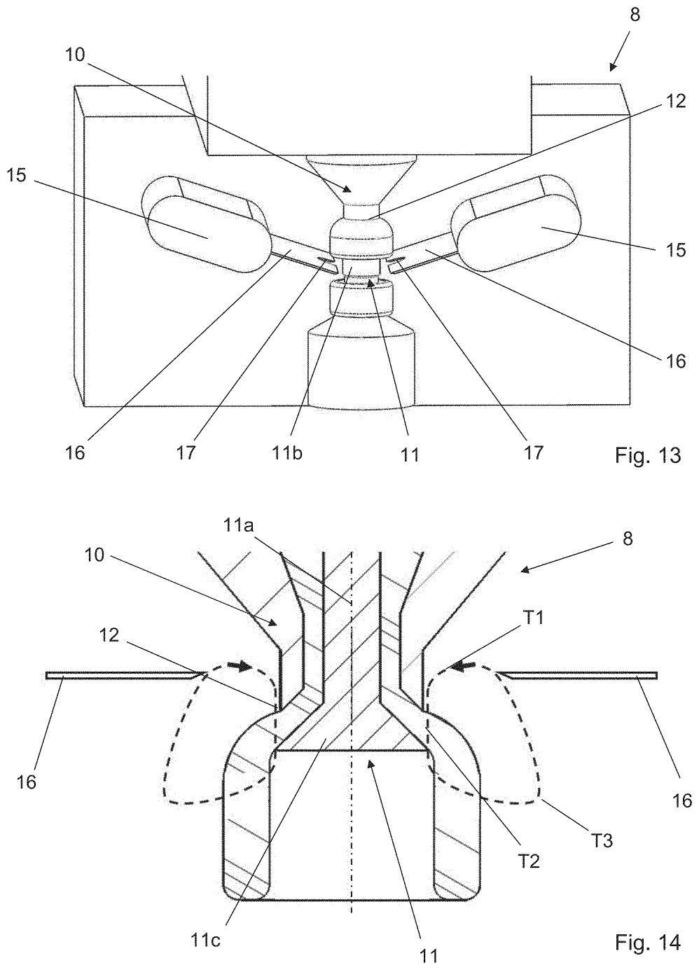

In reference to FIG. 14, the trajectory followed by the cutting or sharp edge of each blade 16 is thus a closed trajectory (T) comprising at least three separate parts, a first part (T1) called cutting part in which the cutting or sharp edge of each blade 16 has a movement speed component essentially in a direction perpendicular to the extrusion direction until the cutting or sharp edge extends aligned with the dosing head 10, a second part (T2) called evacuation part in which the cutting or sharp edge of each blade 16 has a movement speed component essentially in a direction parallel to the extrusion direction, the cutting or sharp edge of each blade 16 procuring the sectioning of the tubular body to form the dose when said blades 16 reach the dispensing orifice 12, and a third part (T3) called return part in which the cutting or sharp edge of each blade 16 has a movement speed component in a direction parallel to the extrusion direction and a movement speed component in a direction perpendicular to the extrusion direction moving away from the dosing head 10 to return the blade 16 to its initial position for a new cycle.

It will be noted that in this alternative embodiment shown in FIG. 14, the punch 11 does not include an outer part 11b, the latter being unnecessary, even if it is shown in FIG. 9.

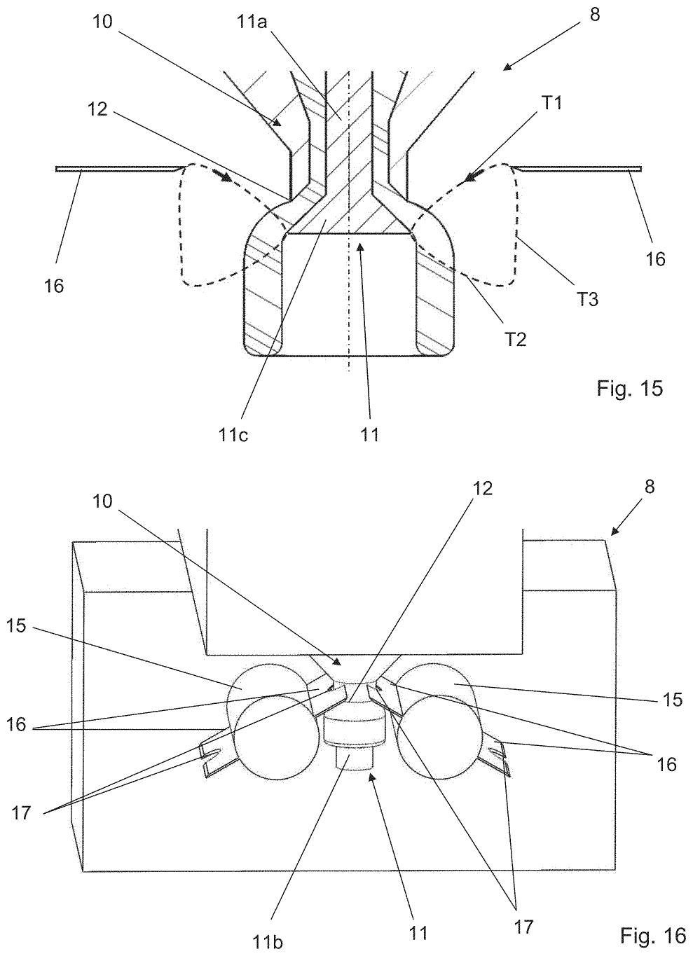

According to a second alternative embodiment of the device according to the invention, in reference to FIG. 15, the connecting rod assembly driving the blade holders 15 on which the blades are fastened procures a closed trajectory different from that previously described. In this alternative embodiment, the trajectory followed by the cutting or sharp edge of each blade 16 is a closed trajectory comprising at least three separate parts (T), a first part (T1) called cutting part in which the cutting or sharp edge of each blade 16 has a movement speed component in a direction perpendicular to the extrusion direction and a movement speed component in a direction parallel to the extrusion direction until the cutting or sharp edge of each blade 16 passes through the wall of the extruded tubular body at the transition part 11c of the punch 11 protruding from the dispensing orifice 12, the cutting or sharp edge of each blade 16 then procuring the sectioning of the tubular body to form the dose, a second part (T2) called evacuation part in which the cutting or sharp edge of each blade 16 has a movement speed component essentially in a direction parallel to the extrusion direction, and a third so-called return part (T3) in which the cutting or sharp edge of each blade 16 has a movement speed component in a direction parallel to the extrusion direction and a movement speed component in a direction perpendicular to the extrusion direction moving away from the dosing head 10 to return the blade 16 to its initial position for a new cycle.

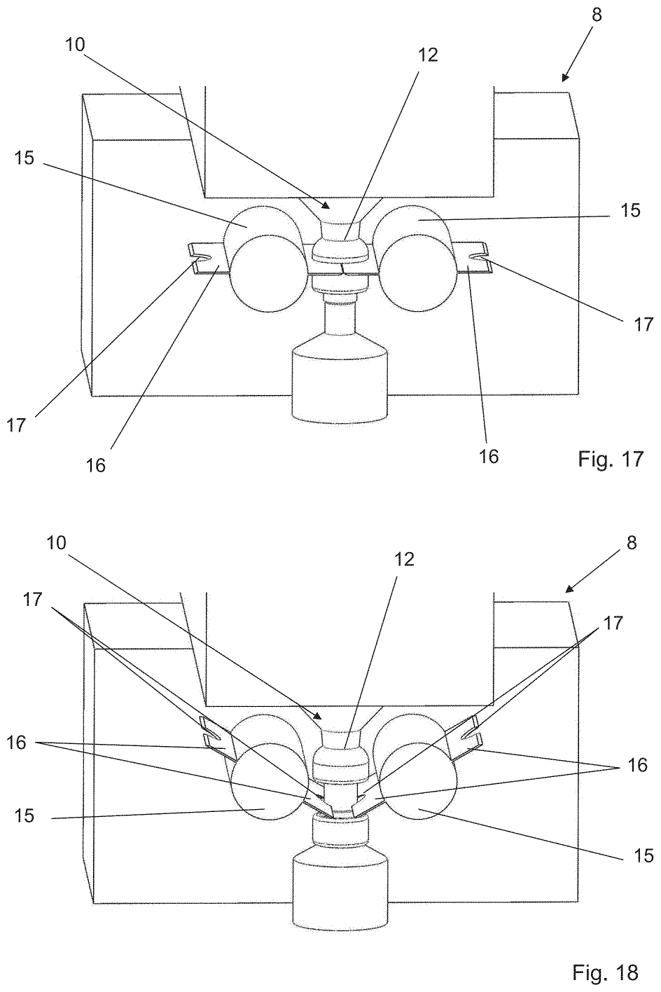

According to a third alternative embodiment of the device according to the invention, in reference to FIGS. 15 to 18, the connecting rod assembly driving the blade holders 15 is chosen such that the sharp edge of the blades 16 performs a circular and symmetrical movement relative to the extruded tubular body, coming closer to one another until touching, thus sectioning the tubular body over the cylindrical part of the punch 11. When the blades 16 move away from the punch 11 (FIGS. 14 and 15), the tangential speed of the sharp edge of each blade 16 undergoes a great acceleration, subsequently lessening, thus creating a propulsion of the dose of material against the bottom and a quick and safe deposition, on the mandrel heads owing to the complement of the blades 16.

Secondarily, the device according to the invention may comprise means for cooling the blades in order to prevent any sticking of the material on the blades. These cooling means, not shown in the figures, may consist of a water circuit, or any other appropriate coolant, made in the blade holders for example.

Advantageously, the device according to the invention may also comprise blower nozzles placed around the punch and above the sectioned dose blowing against the bottom in order to help the placement of the dose and avoid sticking on the blades.

Furthermore, it is clear that the device according to the invention may be used for the molding of components alone like the shoulder without the body of the tube, that the movement speed of the blades is not necessarily identical to the speed of advance of the tubular body.

Furthermore, the shapes of the tubular body, the dose and the parts such as the punch 11 may be of any nature and not necessarily circular. The blades 16 may perform a cyclical movement according to a precise trajectory and stop at a given moment before starting again (blow-by-blow) or perform a continuous movement.

It will be observed that one skilled in the art may easily adjust the shape and volume of the dose based on the cutting rhythm (length), the extrusion speed of the material (length), the space between the transition part of punch and the wall of the dispensing orifice (thickness of the wall of the dose), diameter of the punch (inner diameter of the dose).

Secondarily, said punch may be mounted movably along the extrusion axis using any appropriate means so as to adjust the thickness of the wall of the dose.

Lastly, it is clearly understood that the present invention is in no way limited to the embodiments described above, and that changes may be made thereto without going beyond the scope of the appended claims.

1. A device for dosing of plastic, comprising: an extrusion head having a dispensing orifice and a punch extending in the dispensing orifice coaxially thereto, an extruded tubular body, and cutting means for separating a dose of said plastic in a tubular or annular section, wherein said cutting means have at least two elements having at least one cutting edge, extending on either side of the dispensing orifice, and secured to driving means for symmetrically moving the at least two elements relative to a longitudinal axis of the tubular body until the tubular body is sectioned by said at least two elements to form the dose.

2. The device according to claim 1, wherein a trajectory followed by the cutting edge of each of the at least two elements is a closed trajectory.

3. The device according to claim 2, wherein the cutting edge of each of the at least two elements includes, on at least part of the trajectory, a first movement speed component in a direction perpendicular to an extrusion direction and a second movement speed component in the the extrusion direction.

4. The device according to claim 3, wherein the second movement speed component is substantially identical to a movement speed of the extruded tubular body.

5. The device according to claim 4, wherein the second movement speed component is greater than the movement speed of the extruded tubular body in order to propel the dose in the extrusion direction.

6. The device according to claim 1, wherein said punch comprises at least a cylindrical inner part with a diameter smaller than an inner diameter of the dispensing orifice, and a transition part protruding from the dispensing orifice.

7. The device according to claim 6, wherein said punch comprises an outer part that is also cylindrical, with a diameter larger than the diameter of the inner part, the transition part being between the inner part and the outer part of the punch and having a frustoconical shape.

8. The device according to claim 6, wherein each of the at least two elements has a cutout positioned at the cutting edge.

9. The device according to claim 8, wherein said cutout has an arc shape with a curve radius substantially equal to a curve radius of an outer part of the punch.

10. The device according to claim 8, wherein said cutout has a dimension slightly larger than a dimension of an outer part of the punch so as to provide a clearance between said at least two elements and said punch.

11. The device according to claim 6, wherein a trajectory followed by the cutting edge of each of the at least two elements is a closed trajectory comprising at least three separate parts, a cutting part in which the cutting edge of each of the at least two elements has a movement speed component in a direction perpendicular to an extrusion direction until the cutting edge is aligned with the extrusion head, an evacuation part in which the cutting of each of the at least two elements has a movement speed component in a direction parallel to the extrusion direction, the cutting edge of each of the at least two elements sectioning the extruded tubular body to form the dose when said at least two elements reach a distal end of the transition part of the punch, and a return part in which the cutting edge of each of the at least two elements has a first movement speed component in a direction parallel to the extrusion direction and a second movement speed component in a direction perpendicular to the extrusion direction.

12. The device according to claim 6, wherein a trajectory followed by the cutting edge of each of the at least two elements is a closed trajectory comprising at least three separate parts, a cutting part in which the cutting edge of each of the at least two elements has a first movement speed component in a direction perpendicular to an extrusion direction and a second movement speed component in a direction parallel to the extrusion direction until the cutting edge passes through a wall of the extruded tubular body at the transition part of the punch protruding from the dispensing orifice, the cutting edge of each of the at least two elements then sectioning the extruded tubular body to form the dose, an evacuation part in which the cutting edge of of the at least two elements has a movement speed component in a direction parallel to the extrusion direction, and a return part in which the cutting edge of each of the at least two elements has a first movement speed component in a direction parallel to the extrusion direction and a second movement speed component in a direction perpendicular to the extrusion direction.

13. The device according to claim 7, wherein a trajectory followed by the cutting or sharp edge of each of the at least two elements is a closed trajectory comprising at least three separate parts, a cutting part in which the cutting edge of each of the at least two elements has a first movement speed component in a direction perpendicular to an extrusion direction and a second movement speed component in a direction parallel to the extrusion direction until the cutting edge passes through a wall of the extruded tubular body at the outer part of the punch protruding from the dispensing orifice, the cutting edge of each of the at least two elements sectioning the extruded tubular body to form the dose, an evacuation part in which the cutting edge of each of the at least two elements has a movement speed component essentially in a direction parallel to the extrusion direction, and a return part in which the cutting edge of each of the at least two elements has a first movement speed component in a direction parallel to the extrusion direction and a second movement speed component in a direction perpendicular to the extrusion direction.

14. The device according to claim 13, wherein the cutting edge passes through the wall of the extruded tubular body at a free end of the outer part of the punch protruding from the dispensing orifice.

15. The device according to claim 13, wherein the cutting edge passes through the wall of the extruded tubular body at the outer part of the punch protruding from the dispensing orifice, in a central part of said outer part.

16. The device according to claim 13, wherein the cutting edge passes through the wall of the extruded tubular body at the outer part of the punch protruding from the dispensing orifice, in a proximal part of said outer part.
